(19) United States
(12) Patent Application Publication
(10) Pub. No.: US 2010/0049813 A1
(43) Pub. Date: Feb. 25, 2010

(54) METHOD AND SYSTEM FOR DETERMINING A CONTEXT OF A MESSAGE

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/519,867

(22) PCT Filed: Jul. 3, 2008
(86) PCT No.: PCT/IN08/00421

§ 371 Date: Jun. 18, 2009

(30) Foreign Application Priority Data
Jul. 3, 2007 (IN) 1256/MUM/2007

(51) Int. Cl. G06F 15/16

(52) U.S. Cl. 709/206

(57) ABSTRACT

The present invention relates to a system and method for determining a context of a message which has one or more domain names associated with it. The method comprises extracting the domain names from the message. The domain names correspond to a sender of the message, a recipient of the message and/or one or more users marked on the message. The domain names are then analyzed and a context of the message is determined based on the analyzing step. In an embodiment, the method further comprises inserting in the message commercial content that is relevant to the context of the message.

### FIELD OF THE INVENTION

The invention relates generally to determining context of a message and specifically, to method and system for determining context of a message using one or more domain names associated with the message.

### BACKGROUND OF THE INVENTION

Various Internet services nowadays are provided free, with the revenue model being, building an audience and selling advertisement. These include services like email, chat, Voice over Internet Protocol (VoIP), blogs, and many other services. In order to successfully display appropriate commercial content or advertisements to a user, it would generally be beneficial to identify the topic or subject that the user may be interested in. For instance if a user is reading a web page then ads related to the content on the web page maybe displayed to the user. Similarly, if a user is reading an email, then commercial content relevant to the email content can be displayed to the user. Such techniques for determining user interest are known in the art. However, in several scenarios the body of the text may be too small to determine the user interest from. It may be difficult to surmise the topic of the content of the email from the email content itself.

Hence there is a need to identify other sources that can be used to determine the context of an email or webpage in addition to the actual content of the email or the webpage.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of a method for determining the context of a message using one or more domain names associated with the message in accordance with an embodiment of the present invention.

FIG. 2 illustrates a block diagram of a system for determining the context of a message using one or more domain names associated with the message in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to determining a context of a message. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of determining a context of a message described herein. The non-processor circuits may include, but are not limited to, a radio receiver, a radio transmitter, signal drivers, clock circuits, power source circuits, and user input devices. As such, these functions may be interpreted as steps of a method and system for determining a context of a message. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to determining context of a message using one or more domain names associated with the domain name. The message can be, but is not limited to, an email, a chat message or an application message. If the message is an email, the domain names associated with the message can be derived from a sender email address, one or more recipient email addresses, or domain names included within the body of the email, say from a chain of previous recipients.

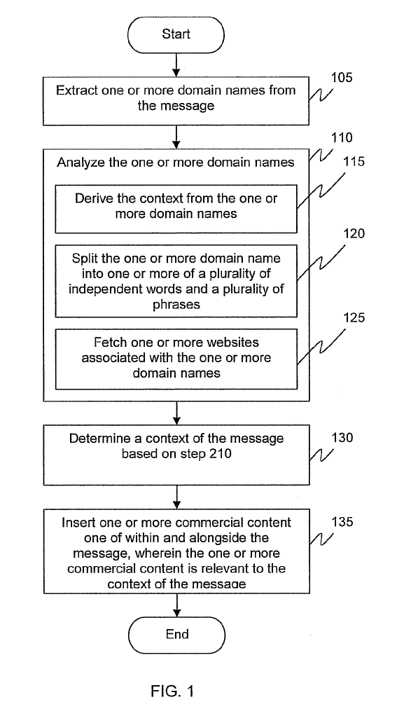

Referring to FIG. 1, a flow diagram of a method for determining the context of a message using one or more domain names associated with the message is shown in accordance with an embodiment of the present invention. As step 105, one or more domain names are extracted from the message. The domain names can correspond to a sender of the message, a recipient of the message and/or one or more users marked on the message. The message can be an email, a chat message, an application message etc. The domain names can correspond to, say, the sender's email address, the recipient's email address and/or the email addresses included in the email. For instance, if the message is an email, the domain names associated with the email can be within the email address such as <user1>@<domain>.com or <user2>@<domain>.net etc. These domain names can include the sender's email address, one or more recipient's email addresses, email address of one or more users marked on the email, email address in the previous chain of email, Universal Resource Locations (URLs) included in the email content etc.

The domain names extracted from the message are then analyzed at step 110. Those skilled in the art will appreciate that the domain names can indicate a profession of a user, an interest of a user, a website from where the context can be derived, etc.

In an embodiment, the context of the message may directly be derived from the domain names, at step 115. For instance, the sender's email address can be user1@travel.com and the recipient's email address can be user2@software.com. During the analysis, it can be determined that the interests of the sender and the recipient include ‘travel’ and ‘computer software’.

In another embodiment of the present invention, the domain names can comprise more than one word. In this case, the domain names can be split into independent words are phrases, at step 120. For instance, domain name such as XYZtravel.com and ABCsoftware.com can be extracted. These domain names can be split into independent words such as “XYZ travel” and “ABC software”.

Further, the independent words and phrases obtained from the domain names and synonyms and similar words corresponding to the independent words and phrases can be used as the context of the domain names.

In yet another embodiment, the analyzing step includes fetching one or more websites associated with the domain names at, step 125. Those skilled in the art will appreciate that a program can be used to fetch the websites associated with the domain names. For instance, in the example above, websites associated with XYZtravel.com and ABCsoftware.com can be fetched, which may be “www.xyztravel.com” and “www.abcsoftware.com”. The content from such websites can be obtained and the topics relevant to the content can be extracted. The extracted topics can be used as the context of the domain names.

In another instance, if an email is sent from ken@rackspace.com to john@somedomain.com, an assumption is made that John maybe generally be interested in dedicated servers since the ‘www.rackspace.com’ website has content related to dedicated servers, web hosting, web infrastructure etc. Similarly, if an email is sent from ken@microsoft.com to john@dorianfurniture.com, the domain names ‘microsoft.com’ and ‘dorianfurniture.com’ can be extracted and split as needed and an assumption can be made that John and Ken maybe interested in software solutions, since the sender is a person from Microsoft, and in furniture, since the recipient has a furniture related domain name.

At step 130, the context of the message is determined based on the analysis at step 110. In the example above, the context of the email can be determined to be ‘travel’ and ‘software’.

In an embodiment of the present invention, the context determined at step 130 can be used to insert relevant commercial content within or alongside the message, at step 135. This ensures that the commercial content is better targeted to the recipient of the message. Thus, the commercial content, which is relevant to the domain names included in an application, can be provided in various forms within that application, and all such methods are within the scope of the present invention.

Those skilled in the art shall appreciate that commercial content can be any content that can either have a commercial value such as advertising content, or content that may lead a user to purchase a product or service or even content that can merely be informational in nature such as the weather of a city or stock quotes for the day or restaurants in places the user intends to visit or any such information. Further, those skilled in the art shall also appreciate that the present invention is not only restricted to email systems and may extend to chat programs and any other application that utilizes a domain name.

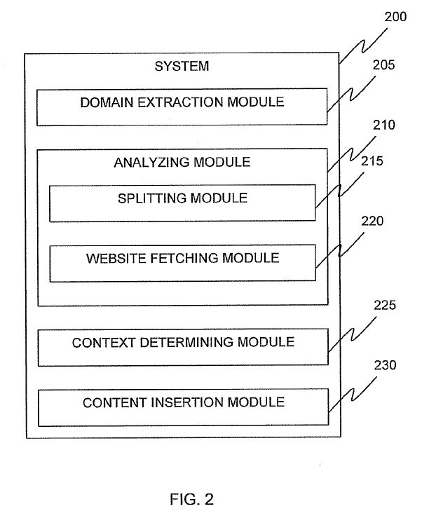

Turning now to FIG. 2, a block diagram of a system 200 for determining the context of a message using one or more domain names associated with the message is shown in accordance with an embodiment of the present invention. System 200 includes a domain extracting module 205 for extracting the domain names from the message. As mentioned earlier, if the message is an email, the domain names can be extracted from a sender's email address, a recipient's email address and/or from email addresses of users marked on the email. Domain extracting module 205 can also extract the domain names from URLs included in the message.

System 200 further comprises an analyzing module 210 for analyzing the domain names. Analyzing module 210 can derive the context directly from the domain name. So, if an email with sender email address as user1@travel.com and recipient email address as user2.software.com, then analyzing module 210 can directly derive the context as ‘travel’ and ‘software’ from the domain names ‘travel.com’ and ‘software.com’.

In an embodiment of the present invention, analyzing module 210 further includes a splitting module 215. Splitting module 215 is configured to split the domain names into independent words and/or independent phrases. Splitting module 215 may further be configured to obtain synonyms or similar words corresponding to the independent words or phrases. The independent words and phrases, and the synonyms or similar words corresponding to the independent words and phrases can be uses as the context of the domain name. Splitting of domain names is explained in detail in conjunction with FIG. 1 above.

In yet another embodiment of the present invention, analyzing module 210 includes a website fetching module 220. Website fetching module 220 is configured to fetch one or more websites associated with the domain names. In an embodiment, website fetching module 220 is a program that fetches the websites associated with the domain names. Website fetching module 220 obtains the content from the one or more websites and extracts one or more topics relevant to the content. The topics are, then, used as the context of the domain name. Fetching of websites is explained in detail in conjunction with FIG. 1 above.

A context determining module 225 then determines the context of the message based on the analysis of analyzing module 210.

In an embodiment of the present invention, system 200 further comprises a content insertion module 230. Content insertion module 230 is configured to insert commercial content relevant to the context determined by context determining module 230 within it alongside the message. Those skilled in the art will realize that the content insertion module 230 can obtain the commercial content from an ad server serving the commercial content. Insertion of relevant commercial content in the message ensures better targeting.

Hence, the present invention discloses a method whereby commercial content can be displayed to a user based on the domain name. This is additionally useful in scenarios where it may be difficult to surmise the topic of the content of the message from the actual message content itself. Those skilled in the art shall appreciate that a domain name can be used for displaying commercial content for any applications that use domain names for any form of communication.

What is claimed is:

1. A method of determining a context of a message, wherein one or more domain names are associated with the message, the method comprising:
extracting the one or more domain names from the message, wherein the one or more domain names correspond to one or more of a sender of the message, a recipient of the message and one or more users marked on the message;
analyzing the one or more domain names; and
determining a context of the message based on the analyzing step.

2. The method of claim 1, wherein the one or more domain names are extracted from one or more of:
a sender email address;
a recipient email address;
one or more email addresses of the one or more users marked on the message; and
one or more Universal Resource Locations (URLs) in the message.

3. The method of claim 1, wherein the analyzing step comprises performing one or more of:
deriving the context from the one or more domain names;
splitting the one or more domain names into one or more of a plurality of independent words and a plurality of phrases; and
fetching one or more websites associated with the one or more domain names.

4. The method of claim 3, wherein a program fetches the one or more websites.

5. The method of claim 3, wherein the splitting step further comprises:
using one or more of the plurality of independent words, the plurality of phrases, one or more of a plurality synonyms and a plurality of similar words corresponding to one or more of the plurality of independent words and the plurality of phrases as the context of the one or more domain names.

6. The method of claim 3, wherein the fetching step further comprises:
obtaining a content from the one or more websites;
extracting one or more topics relevant to the content;
using the one or more topics as the context of the one or more domain names.

7. The method of claim 1, wherein the message is one or more of an email, a chat message and an application message, wherein the sender sends the one or more of the email and the chat message to the recipient.

8. The method of claim 1, wherein the context comprises one or more of an interest of one or more of the sender and the recipient and an occupation of one or more of the sender and the recipient.

9. The method of claim 1 further comprises:
inserting one or more commercial content one of within and alongside the message, wherein the one or more commercial content is relevant to the context of the message.

10. A system for determining a context of a message, wherein one or more domain names are associated with the message, the system comprising:
a domain extracting module, the domain extracting module extracting the one or more domain names from the message, wherein the one or more domain names correspond to one or more of a sender of the message, a recipient of the message and one or more users marked on the message;
an analyzing module, the analyzing module analyzing the one or more domain names; and
a context determining module, the context determining module determining a context of the message.

11. The system of claim 10, wherein the domain extracting module extracts the one or more domain names from one or more of:
a sender email address;
a recipient email address;
one or more email addresses of the one or more users marked on the message; and
one or more Universal Resource Locations (URLs) in the message.

12. The system of claim 10, wherein the analyzing module derives the context from the one or more domain names.

13. The system of claim 10, wherein the analyzing module further comprises one or more of:
a splitting module, the splitting module configured to split the one or more domain names into one or more of a plurality of independent words and a plurality of phrases; and
a website fetching module, the website fetching module configured to fetch one or more websites associated with the one or more domain names.

14. The system of claim 13, wherein the website fetching module is a program.

15. The system of claim 13, wherein the splitting module is further configured to:
use one or more of the plurality of independent words, the plurality of phrases, one or more of a plurality synonyms and a plurality of similar words corresponding to one or more of the plurality of independent words and the plurality of phrases as the context of the one or more domain name.

16. The system of claim 13, wherein the website fetching module is further configured to:
obtain a content from the one or more websites;
extract one or more topics relevant to the content;
use the one or more topics as the context of the one or more domain name.

17. The system of claim 10 further comprises a content insertion module, the content insertion module configured to:
insert one or more commercial content one of within and alongside the message, wherein the one or more commercial content is relevant to the context of the email.
